(19) United States
(12) Patent Application Publication
(10) Pub. No.: US 2026/0094345 A1
(43) Pub. Date: Apr. 2, 2026

(54) RENDERING USING MACHINE LEARNING TO GENERATE INDIRECT ILLUMINATION

(71) Applicant: Advanced Micro Devices, Inc., Santa Clara, CA (US)

(72) Inventors: Sung Ye Kim, Folsom, CA (US); Rama Sharma Bangalore Harihara, Santa Clara, CA (US)

(73) Assignee: Advanced Micro Devices, Inc., Santa Clara, CA (US)

(21) Appl. No.: 18/899,611

(22) Filed: Sep. 27, 2024

(51) Int. Cl. G06T 15/06; G06T 15/50

(52) U.S. Cl. CPC G06T 15/06; G06T 15/506

(57) ABSTRACT

In ray tracing or other rendering techniques, lighting applied to objects can be divided into two categories: direct lighting and indirect lighting. Direct lighting is light whose rays are emitted from a light source and are directly incident on an object of a scene without bouncing. Indirect lighting is all other lighting—light that bounces off of one or more objects in a scene and illuminates one or more objects of the scene. While direct lighting is relatively straightforward to calculate, performing ray tracing to determine indirect lighting can be very computationally intensive due to the significantly greater number of rays being simulated. For this reason, a machine learning model is being disclosed herein that generates indirect lighting given other information about the scene.

### BACKGROUND

In image synthesis, ray tracing is utilized to find a nearest intersection of a given ray with a scene where light propagation is simulated. Advances in ray tracing are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates direct and indirect illumination, according to an example;

FIG. 6 illustrates a rendering system for generating an image using a machine learning model for generating indirect illumination, according to an example;

FIG. 7 illustrates an example of a machine learning model for generating indirect illumination;

FIG. 8 illustrates training operations for a machine learning model for generating indirect illumination; and

FIG. 9 illustrates a method for generating an image utilizing a machine learning model for generating indirect illumination, according to an example.

### DETAILED DESCRIPTION

In ray tracing or other rendering techniques, lighting applied to objects can be divided into two categories: direct lighting and indirect lighting. Direct lighting is lighting from rays emitted from a light source and directly incident on an object of a scene. Indirect lighting is all other lighting-light that bounces off of one or more objects in a scene and illuminates one or more objects of the scene.

While direct lighting is relatively straightforward to calculate, performing ray tracing to determine indirect lighting can be very computationally intensive due to the significantly greater number of rays being simulated. For this reason, a machine learning model is being disclosed herein that generates indirect lighting given other information about the scene.

More specifically, the machine learning model is trained to accept a rendered direct illumination image as well as additional “guide buffer” information and to generate indirect illumination information in response. Then, the indirect illumination information is applied to the direct illumination image to generate a final output image. This output image, which represents a fully illuminated image, represents a result generated more efficiently than if the image were fully rendered without the machine learning model.

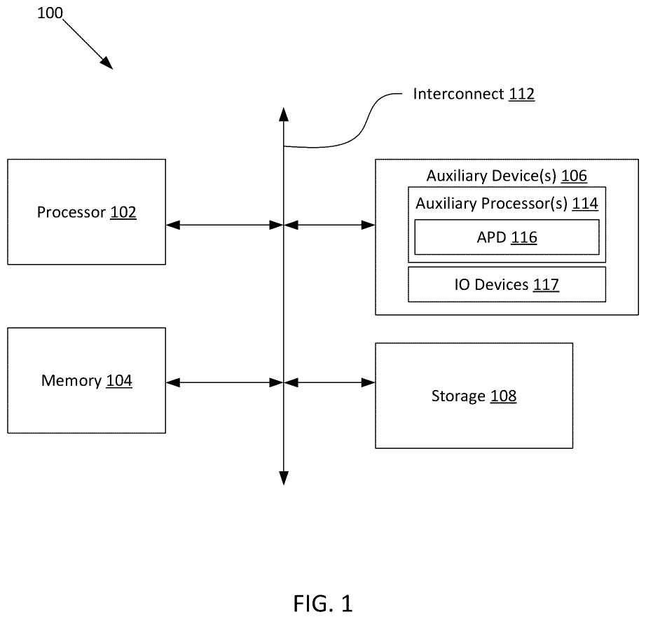

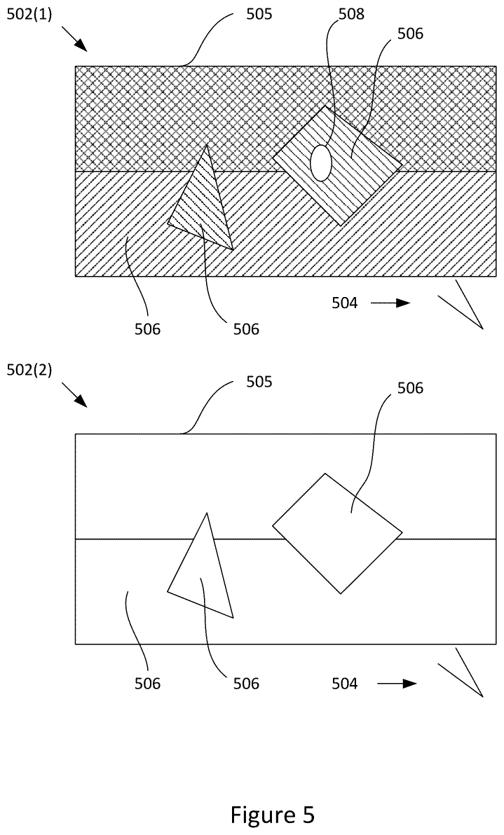

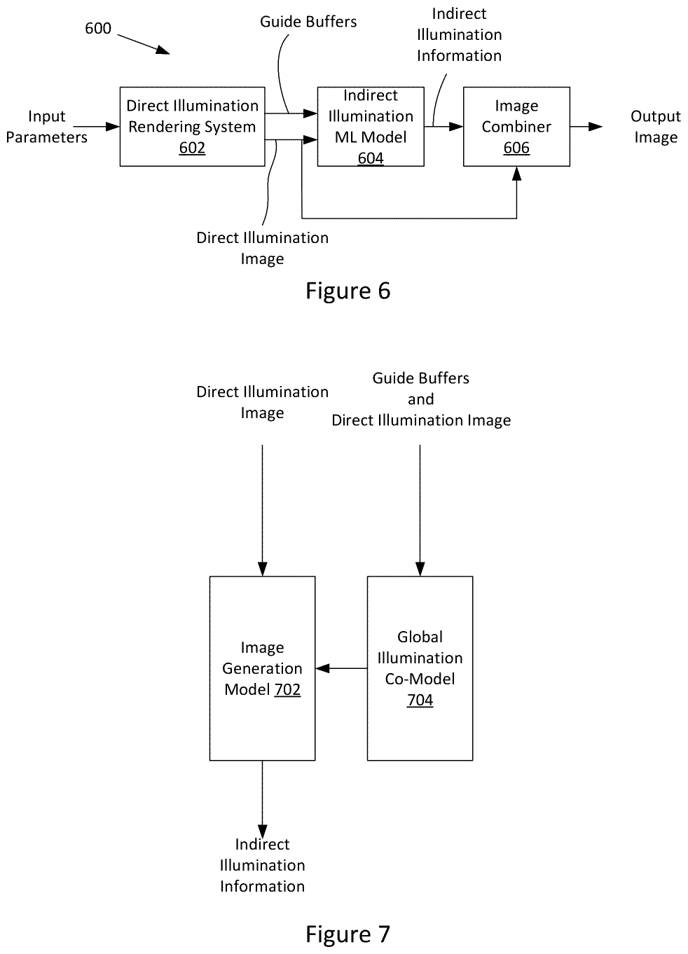

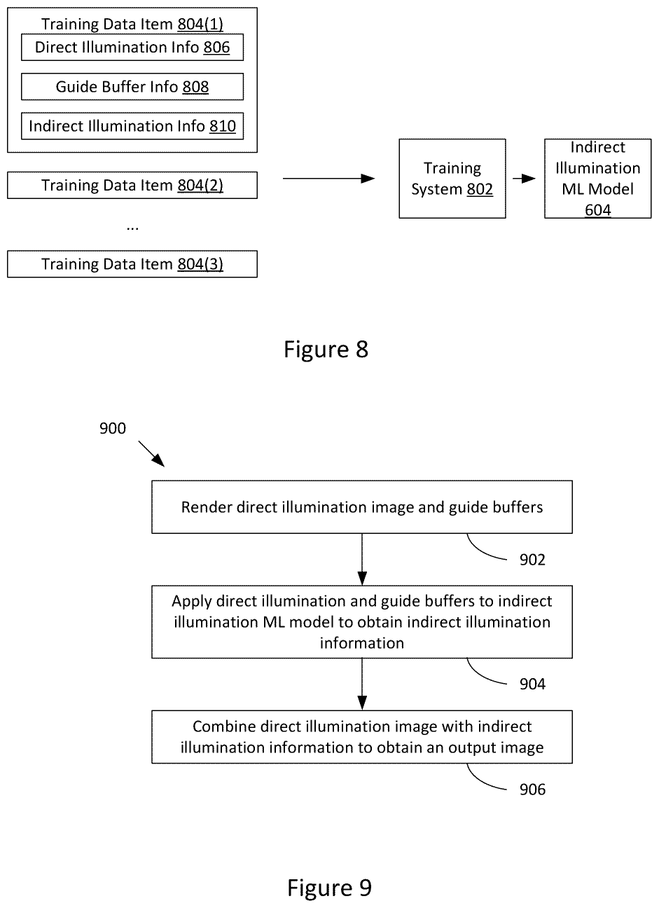

FIGS. 1-4 illustrate an example system on which ray tracing is performed. FIG. 5 illustrates direct and indirect illumination. FIG. 6 illustrates a rendering system for generating an image using a machine learning model for generating indirect illumination. FIG. 7 illustrates an example of such a machine learning model. FIG. 8 illustrates training operations and FIG. 9 illustrates an example method for rendering a scene using a machine learning model for generating indirect illumination.

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

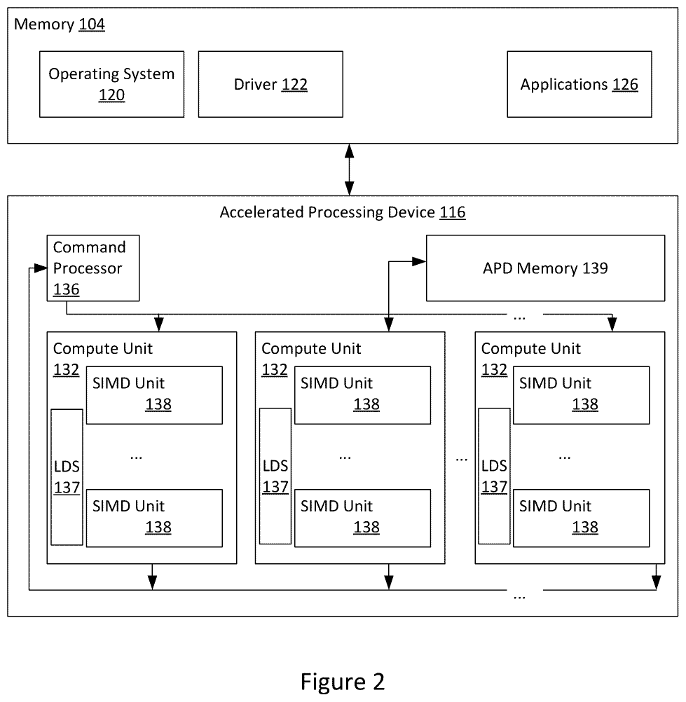

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some examples, the driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image based on commands received from the processor 102. The APD 116 also executes compute processing operations that are not directly related to graphics operations, such as operations related to video, physics simulations, computational fluid dynamics, neural computing, artificial intelligence (AI) tasks, or other tasks, based on commands received from the processor 102. In some examples, the APD 116 does not perform graphics operations.

In this example, the APD 116 includes compute units 132 that include one or more SIMD units 138 that perform operations at the request of the processor 102 in a parallel manner according to a SIMD paradigm. The compute units 132 are sometimes referred to as “parallel processing units” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations as well as various compute or AI operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

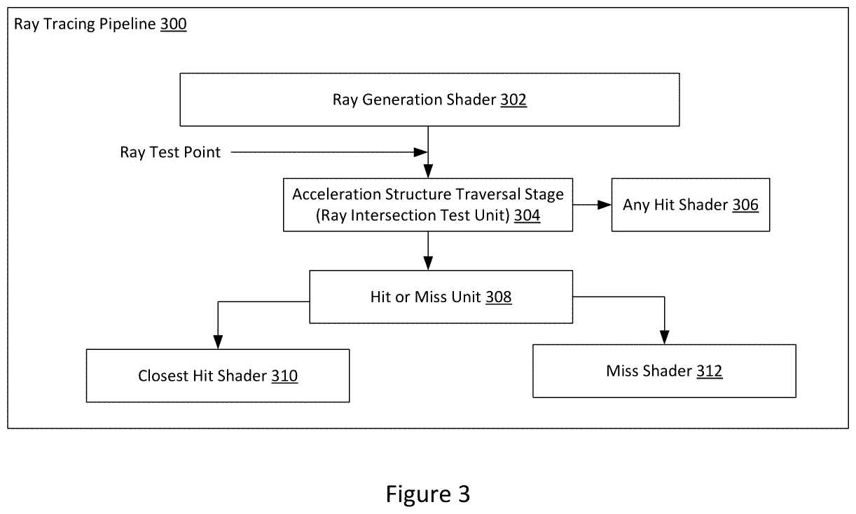

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

Any portion of the ray tracing pipeline 300 is implemented as software, hardware (e.g., circuitry such as a programmable or non-programmable processor, of fixed function circuitry) or a combination thereof, and can be implemented partially or fully on the APD 116. In various such examples, the software executes on the SIMD units 138 and/or on a different processor. More specifically, the various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle or procedural primitive and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. Another use is to spawn additional rays for reflections and/or global illumination effects. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

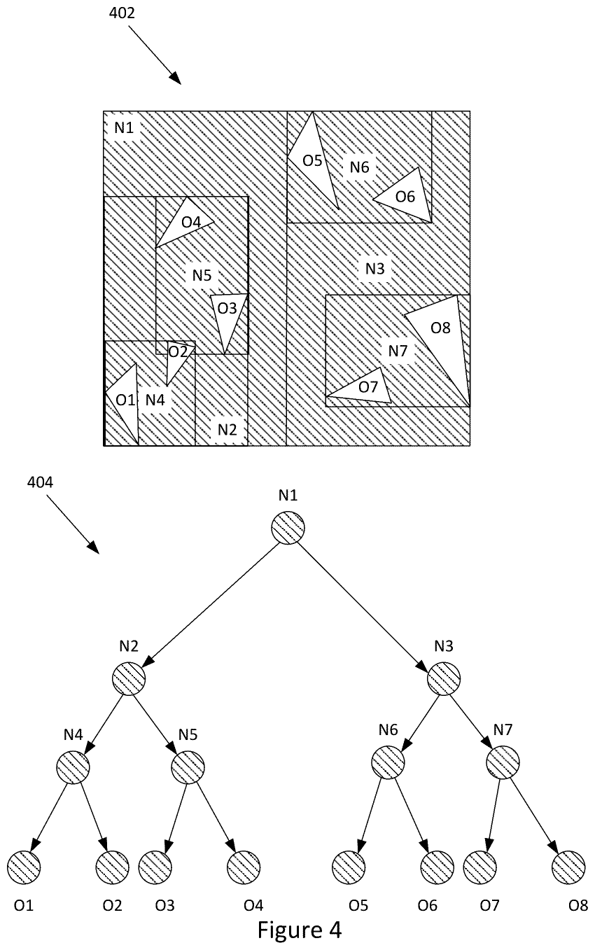

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that No succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

In some examples, the ray tracing pipeline 300 is configured to render a scene using a combination of direct lighting and indirect lighting. Direct lighting is lighting directly cast on an object by a light source in a scene. In other words, with direct lighting, objects in the scene are illuminated by rays cast from a light source in the scene. This direct lighting illuminates some portion of the scene, but does not provide a fully and naturally illuminated scene. The missing component is indirect illumination-illumination cast onto objects in the scene by one or more bounced rays. For example, many rays cast from a light source bounce off of objects and illuminate other objects. Each ray may bounce multiple times in order to fully illuminate a scene, and each bounce typically represents a new ray cast. Because each ray cast is expensive, techniques are provided herein whereby a trained machine learning (“ML”) model generates indirect lighting based on direct lighting and “guide buffer” information generated through non-ML techniques.

FIG. 5 illustrates an example scene 502. The scene 502 includes a plurality of objects 506 and a light source 504. The light source 504 is shown outside of the visible boundary 505 of the scene 502, though its effects are visible in the scene 502. Further, it is not necessary for a light source 504 to be external to such visible boundary 505.

In scene 502(1), direct illumination of the objects 506 is shown. Specifically, light rays from the light source 504 are directly incident on an object. A direct illumination area 508 is shown, and this is the area that is directly illuminated by the light rays emitted by the light source 504. It should be understood that scene 502(1) is the scene generated by the ray tracing pipeline 300 (or other rendering technique such as a rasterization based technique) determining contributions to objects from lighting by casting rays from the light source 504 towards the scene 502. These lighting contributions do not take into account indirect lighting—that is, light incident on objects that come from a source other than the light source 504 (such as, e.g., bounced off of a different object). In general, a scene rendered with direct lighting and without indirect lighting is a scene in which the lighting contributions to objects are determined based on the rays cast from the light sources for the scene, but not from any ray that originates from any other source (such as bounced off of another object). Put differently, rendering a direct illumination scene includes obtaining lighting contributions by casting rays from the light sources of the scene and identifying the objects and positions within those objects intersected by such rays, as well as calculating the degree of lighting contribution, but such rendering does not include generating additional “bounce rays” (rays emitted from a light source or bounced off an object and incident on another object) to determine further contribution to the lighting for objects. In some examples, lighting contribution to objects is determined only based on directly incident rays—that is—rays cast directly from a light source and incident on an object. It should be understood that in the example scene 502(1) of FIG. 5, the portions of the scene outside of the direct illumination area 508 are lit very little or not at all, which is indicated with the cross-hatching.

By contrast, in the scene 502(2) with indirect illumination, the scene is illustrated with indirect illumination applied. This indirect illumination includes illumination other than that derived from rays that originate from a light source 504 and are directly incident on the objects of the scene 502(2). In various examples, the indirect illumination includes illumination derived from simulated light rays that originate from the light source 504 but that bounce one or more times off of objects in the scene before being incident on the object being indirectly illuminated. In some examples, this indirect illumination is derived from light rays that would be simulated in a ray tracing technique that casts rays from a light source, determines what object(s) such rays intersect, and casts new rays from those objects as “bounce rays,” with additional bounces as necessary, resulting in indirect illumination of the scene 502(2).

FIG. 6 illustrates a rendering system 600 for generating an output image according to an example. The rendering system 600 includes a direct illumination rendering system 602, an indirect illumination machine learning model 604, and an image combiner 606. In some examples, each of these elements (602-606) is implemented as software executing on one or more processors such as the processor 102 or the APD 116. The direct illumination rendering system 602 accepts input parameters (e.g., scene geometry and properties of the geometry and the scene). In some examples, the direct illumination rendering system 602 includes the ray tracing pipeline 300. In some examples, the ray tracing pipeline 300 is programmed to determine the direct lighting contributions from light sources 504 in a scene, by casting rays from the light sources to determine which objects are intersected by the rays and then to light those objects appropriately. Although the direct illumination rendering system 602 is described as part of the ray tracing pipeline 300, alternate implementations are possible. In various examples, the direct illumination rendering system 602 comprises software executing on a processor, circuitry (e.g., digital circuitry such as fixed-function digital circuitry or other circuitry), or a combination thereof. The direct illumination rendering system 602 produces a direct illumination image, which is a rendered version of the scene with direct illumination, but not indirect illumination applied.

The direct illumination rendering system 602 also outputs guide buffers, which is one or more other items of information that assists the indirect illumination ML model 604 to generate an indirect illumination image. In an example, the guide buffers include information, other than the direct illumination information, that is dependent on and/or characterizes the scene being rendered. In some examples, the guide buffers include buffers that store one or more of the following items of information: surface colors, surface normals for surfaces of objects of the scene, material properties for surfaces of the scene (e.g., where examples of materials include an indication of surface roughness, a metallic surface, or other surface types that affect how the surface would appear), indications of the light information that indicates various aspects of the lights of the scene, and camera information. The surface colors are colors of the objects of the scene, and contribute to rendering. The surface normals are directions perpendicular to the plane of the surfaces of the geometry. The indications of light information indicate how many lights there are in the scene, the intensity of those lights, the directionality of the lights, and any other information that characterizes the lights. The camera information includes an indication of various aspects of the camera, such as the position, direction, and field of view of the camera. In some examples, the direct illumination rendering system 602 generates these guide buffers in the course of generating the direct illumination image. For example, the direct illumination rendering system 602 generates (or obtains) information about the normals of the surfaces being rendered, about the lights of the scene, about the camera, about the surface colors, and about other information.

The indirect illumination ML model 604 is a machine learning model that is trained to generate indirect illumination information given the direct illumination image and the guide buffers. More specifically, a training system trains the indirect illumination ML model 604 to generate the indirect illumination information, given the guide buffers and the direct illumination image. Within the rendering system 600, the indirect illumination ML model 604 generates the indirect illumination information, which is applied to the image combiner 606. In some examples, the model 604 is embodied as one or both of software executing on one or more processors such as the processor 102 or the APD 116, hardware (e.g., circuitry such as digital circuitry, including a processor, or as fixed-function digital circuitry), or a combination thereof.

The image combiner 606 applies the indirect illumination information to the direct illumination image to generate an output image which includes direct illumination and indirect illumination and can be considered a “final output image.” In some examples, the indirect illumination information is an image that indicates, for each pixel of the direct illumination image, the amount of light to apply to that pixel. In such examples, the image combiner 606 applies that light to the direct illumination image to generate the output image. Application of light information in this manner can be performed in any technically feasible manner, such as by increasing the luminance of each specified pixel in the direct illumination image by the amount specified in the indirect illumination information. In other examples, the indirect illumination information is not pixel-by-pixel, but is instead provided at a different granularity, such as tile-by-tile (where a tile is a square or rectangle of multiple pixels) or the illumination information is provided object-by-object (e.g., in world space rather than screen space). In any case, the image combiner 606 applies the indirect illumination information by increasing the illumination of the objects of the direct illumination image based on the indirect illumination information. In various examples, the image combiner 606 is software, hardware (e.g., digital circuitry such as a processor), or a combination thereof.

FIG. 7 illustrates an example indirect illumination ML model 700 which is an example of the indirect illumination ML model 604 of FIG. 6. The indirect illumination ML model 700 includes an image generation model 702 and a global illumination co-model 704.

The image generation model 702 is a machine learning model trained to generate indirect illumination information given a direct illumination image as input. More specifically, at some point such as prior to utilization of the image generation model 702, a training system (e.g., a computing device including a processor) trains the image generation model 702 to generate indirect illumination information (e.g., an image or other information specifying indirect illumination) given a corresponding direct illumination image. In some examples, the image generation model 702 is implemented as either a generative network model or a convolutional network model.

The global illumination co-model 704 is a model that is trained to apply adjustments to the operation of the image generation model 702, based on the guide buffers and the direct illumination image. More specifically, the image generation model 702 is a more general model that is trained only on direct illumination images. By contrast, the global illumination co-model 704 is trained to apply adjustments to the operation of the image generation model 702 to cause the output of that model to account for the various factors reflected in the information of the guide buffers. In various examples, each of the image generation model 702 and the global illumination co-model 704 is implemented as a series of convolutional layers, each of which performs convolutions on corresponding layer input with either generative or convolutional neural network architectures. In some examples, one or more convolutional layers of the global illumination co-model 704 provides its output to the subsequent layer of the global illumination co-model 704 as well as to a corresponding layer of the image generation model 702, so that such corresponding layer receives inputs from both a previous layer of the image generation model 702 and a layer of the global illumination co-model 704. As can be seen, the global illumination co-model 704 is a trained machine learning model that provides adjustments based on fine tuning parameters (i.e., guide buffers) to the more generic image generation model 702.

The configuration of having a more “general” image generation model 702 that generates indirect illumination information based on a direct illumination image, along with a more fine-tuned global illumination co-model 704 provides certain benefits. For example, it is possible to use a generally available model as the image generation model 702, as the output of this model can still be altered as needed by the global illumination co-model 704. Further, it is possible to focus training efforts on how the specific features found in the guide buffers affects the final image, without having to expend the effort of updating the weights of the image generation model 702 during training, since in some examples, only the weights of the global illumination co-model are updated.

For inference (i.e., to generate the indirect illumination information), the rendering system 600 applies the direction illumination image to the image generation model 702 and the guide buffers and direct illumination image to the global illumination co-model 704. The global illumination co-model 704 applies adjustments to the internal operations of the image generation model 702 (e.g., modifying the outputs of levels of the image generation model 702 based on intermediate outputs from the global illumination co-model 704) such that the image generation model 702 produces the indirect illumination information which is fine-tuned based on information in the guide buffers.

FIG. 8 illustrates a training operation 800 according to an example. In the training operation 800, a training system 802 accepts training data items 804 and trains the indirect illumination machine learning model 604. In various examples, the training system 802 is a computer device such as the device 100 of claim 1. In some examples, the training system 802 is in the same device as the image generation system of FIG. 6, and in other examples, the training system 802 is in a different device, generating the indirect illumination ML model 604 prior to that model being sent to a different device for use in image generation.

The training data items 804 include direct illumination info 806, guide buffer info 808, and indirect illumination info 810. In some examples, a ray tracing pipeline 300 generates each of these items based on an actual scene. In an example, the ray tracing pipeline 300 renders a scene, generating both direct illumination information 806 (e.g., indications of which portions of the scene are directly illuminated, and the strength of such illumination), indirect illumination info 810 (e.g., indications of which portions of the scene are indirectly illuminated, and the strength of such illumination), and information of the guide buffers. As described above, the guide buffer information is information generated in the course of performing rendering, so that information is available as a result of the rendering operations performed by the ray tracing pipeline 300. As can be seen, the training system 802 trains the indirect illumination ML model 604 to generate the output information-indirect illumination-given the input information including the direct illumination information 806 and the guide buffers. Then, the indirect illumination is compared to the indirect illumination information 810 to optimize error between the output and indirect illumination information 810 during training the indirect illumination ML model 604. The indirect illumination information 810 in the training data items 804 is utilized as the ground truth during training.

In some examples, the training system 802 trains the indirect illumination ML model 604 in the following manner. For each training data item 804, the training system 802 reduces errors in the output indirect illumination information 810 by minimizing difference from the ground truth information—the indirect illumination information 810—and causes the indirect illumination ML model 604 to remove such noise based on the inputs including the direct illumination information 806 and the guide buffers. The training system 802 then adjusts the weights of the indirect illumination ML model 604 to correct the error in the indirect illumination information generation that occurred.

In some examples, the training involves adjusting the weights of the global illumination co-model 704 while holding the weights of the image generation model 702 constant. Specifically, a training system would apply the direct illumination image of a training data item 804 to the image generation model 702 and the guide buffers and direct illumination image of the training data item 804 to the global illumination co-model 704, would obtain the indirect illumination information, would compare that information to the indirect illumination information 810 of the training data item 804, and would update the weights of the global illumination co-model 704 to minimize the error.

FIG. 9 is a flow diagram of a method 900 for generating a rendered image using an indirect illumination ML model 604, according to an example. Although described with respect to the system of FIG. 9, those of skill in the art will understand that any system configured to perform the steps of the method 900 in any technically feasible order falls within the scope of the present disclosure.

At step 902, the rendering system renders a direct illumination image and guide buffers. In some examples, step 902 is performed by a rendering system that includes a ray tracing pipeline 300 which performs operations such as casting rays into the scene being rendered to determine visual characteristics of that scene. In this particular example, the ray tracing pipeline 300 casts rays from one or more light sources to the scene to determine the direct illumination in the scene, but does not cast any “bounce rays,” which are rays that are cast after a primary ray strikes an object. In a ray tracing operation for determining full illumination of a scene, such bounce rays would provide additional, indirect illumination to objects of a scene, but this indirect illumination is not applied in step 902. An advantage of refraining from casting such bounce rays with the ray tracing pipeline 300 is that typically a large number of such rays must be cast in order to determine the full indirect lighting. Thus obtaining indirect lighting information from the indirect illumination ML model 604 significantly reduces the total amount of processing power needed. It should be understood that in some examples, step 902 is performed by a specifically configured ray tracing pipeline 300, which through either or both of programming (e.g., shader programs) and hardware configuration (e.g., setting flags or configuration values via the driver 122) performs the functionality described herein. In some examples, an application 126 requests the driver to configure the ray tracing pipeline 300 in such a manner. The guide buffers include information described elsewhere herein and are generated in the course of producing the direct illumination image. In other words, the ray tracing pipeline 300 determines, renders, or gathers information for the guide buffers for the purpose of producing the direct illumination image, and also outputs this information for use in subsequent operations. Example information that can be stored in the guide buffers is described elsewhere herein.

At step 904, the rendering system 600 applies the direct illumination image and the guide buffers to an indirect illumination ML model 604 to obtain indirect illumination information. As described elsewhere herein, the indirect illumination ML model 604 is a machine learning model that is trained to produce the indirect illumination information described herein, given the direct illumination image and the guide buffers. In some examples, the indirect illumination ML model 604 has an architecture as illustrated in FIG. 7, with an image generation model 702 that is trained to output “generic” or basic indirect illumination information, and a global illumination co-model 704 that is trained to adjust the operations of the image generation model 702 based on the input guide buffers and direct illumination image. As described elsewhere herein, this configuration allows the image generation model 702 to be trained once to produce general output, and then allows the global illumination co-model 704 to be trained in a more fine grained manner, to tweak the output of the image generation model 702 based on the guide buffers in order to produce appropriate output.

In some examples, step 904 is performed in the following manner. Software executing on a processor, such as the driver 122, an application 126, or a shader program, gathers the information to be input to the indirect illumination ML model 604 (e.g., the direct illumination image and the guide buffers) and performs inference using the indirect illumination ML model 604. In some examples, inference includes performing operations to apply these inputs to the architecture of the indirect illumination ML model 604 to obtain corresponding outputs. This inference would include performing the appropriate calculations, such as matrix multiplications and/or other calculations, according to the layers specified by the architecture of the model, and using the weights determined in training.

At step 906, an image combiner 606 combines the direct illumination image obtained at step 902 with the indirect illumination information obtained at step 904. In some examples, the image combiner 606 applies the indirect illumination to the direct illumination image by increasing the luminance of the pixels in the direct illumination image based on the luminance specified by the indirect illumination information. In some examples, wherein the indirect illumination information is a two dimensional array of color values, the image combiner 606 simply adds the values of the components of the direct illumination image and the indirect illumination information. In some such examples, the direct illumination information and/or indirect illumination information are normalized in order for such a sum to properly fit within the value ranges of the color space. The image combiner 606 may perform any other technically feasible operation to combine the indirect illumination information with the direct illumination image in order to generate the final image, with the commonality being that the image combiner 606 applies the luminance specified by the indirect illumination information to the direct illumination image, resulting in a brighter and more globally illuminated image (as compared with a direct illumination image in which, for example, the portions of objects that are illuminated is primarily the portions of objects directly illuminated by the light sources). In some examples, the image combiner 606 is one or both of hardware (e.g., a processor or digital circuitry configured to perform the operations described herein), software (e.g., a program executing on a processor such as the processor 102 or the APD 116), or a combination thereof.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the accelerated processing device 116, the scheduler 136, the compute units 132, the SIMD units 138, local data store 137, APD memory 139, ray tracing pipeline 300, ray generation shader 302, acceleration structure traversal stage 304, any hit shader 306, hit or miss unit 308, closest hit shader 310, miss shader 312, direct illumination rendering system 602, indirect illumination ML model 604, image combiner 606, image generation model 702, global illumination co-model 704, or training system 802, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
rendering a direct illumination image and generating one or more guide buffers;
applying the direct illumination image and the one or more guide buffers to an indirect illumination machine learning model to obtain indirect illumination information; and
combining the direct illumination image with the indirect illumination information to obtain an output image.

2. The method of claim 1, wherein the rendering is performed via ray tracing.

3. The method of claim 2, wherein the ray tracing is performed without generating bounce rays that illuminate one or more objects based on reflected light rays not emitted from a light source.

4. The method of claim 1 wherein the guide buffers include information other than the direct illumination image that is dependent on or characterizes a scene from which the direct illumination image is generated.

5. The method of claim 1, wherein applying the direct illumination image and the one or more guide buffers to the indirect illumination machine learning model includes performing inference on the indirect illumination machine learning model.

6. The method of claim 5, wherein the indirect illumination machine learning model comprises an image generation model and a global illumination co-model.

7. The method of claim 6, wherein the global illumination co-model is configured to apply adjustments to the image generation model, the adjustments being based on the one or more guide buffers.

8. The method of claim 1, wherein the one or more guide buffers include one or more of surface normals, surface colors, material properties, light information, and camera information.

9. The method of claim 1, wherein the combining comprises modifying the illumination of the direct illumination image based on the indirect illumination information.

10. The method of claim 6, wherein the image generation model is implemented as either a generative architecture or a convolutional neural network architecture.

11. A system comprising:
a memory configured to store information for an indirect illumination machine learning (“ML”) model; and
a processor configured to:
render a direct illumination image and generating one or more guide buffers;
apply the direct illumination image and the one or more guide buffers to the indirect illumination machine learning model to obtain indirect illumination information; and
combine the direct illumination image with the indirect illumination information to obtain an output image.

12. The system of claim 11, wherein the rendering is performed via ray tracing.

13. The system of claim 12, wherein the ray tracing is performed without generating bounce rays that illuminate one or more objects based on reflected light rays not emitted from a light source.

14. The system of claim 11, wherein the guide buffers include information other than the direct illumination image that is dependent on or characterizes a scene from which the direct illumination image is generated.

15. The system of claim 11, wherein applying the direct illumination image and the one or more guide buffers to the indirect illumination machine learning model includes performing inference on the indirect illumination machine learning model.

16. The system of claim 15, wherein the indirect illumination machine learning model comprises an image generation model and a global illumination co-model.

17. The system of claim 16, wherein the global illumination co-model is configured to apply adjustments to the image generation model, the adjustments being based on the one or more guide buffers.

18. The system of claim 11, wherein the one or more guide buffers include one or more of surface normals, surface colors, material properties, light information, and camera information.

19. The system of claim 16, wherein the image generation model is implemented as either a generative architecture or a convolutional neural network architecture.

20. A non-transitory computer-readable medium storing instructions that, when executed by a processor, cause the processor to perform operations comprising:
rendering a direct illumination image and generating one or more guide buffers;
applying the direct illumination image and the one or more guide buffers to an indirect illumination machine learning model to obtain indirect illumination information; and
combining the direct illumination image with the indirect illumination information to obtain an output image.
